(19) United States
(12) Patent Application Publication
(10) Pub. No.: US 2020/0163743 A1
(43) Pub. Date: May 28, 2020

(54) DENTAL TRACTION DEVICE

(71) Applicants: Yi-Wen Chen, New Taipei City (TW); Hsi-Yuan Lin, New Taipei City (TW)

(72) Inventors: Yi-Wen Chen, New Taipei City (TW); Hsi-Yuan Lin, New Taipei City (TW); Hao-Ming Chiu, New Taipei City (TW)

(21) Appl. No.: 16/198,767

(22) Filed: Nov. 22, 2018

(51) Int. Cl. A61C 7/22

(52) U.S. Cl. CPC A61C 7/22

(57) ABSTRACT

A dental traction device comprises an extension main-body, a tractive-body, a blocking-stopping-body, and a seat-body. When using, the dental orthotics are firstly set and the dental correction archwire connection is set, and the bone nail is set at the gum; then, the seat-body is fixed on the dental correction archwire; one end of the elastic element is bypass the blocking-stopping-body to stick and engage on the tractive-body and the other end is stuck and engaged on the bone nail; then the blocking-stopping-body is cooperated with the tractive-body to fix the elastic element to avoid falling-off; and the contraction elastic force of the elastic element generates the pulling force to the dental correction archwire and the teeth by using the extension main-body as the force moment to produce the traction correction effect; and so as to achieve the practicality and progressiveness which is convenient in use and avoids falling-off.

### (A) TECHNICAL FIELD OF THE INVENTION

The present invention provides a dental traction device, and especially relates to a dental traction device which is convenient in use and avoids falling-off.

### (B) DESCRIPTION OF THE PRIOR ART

Generally, teeth can be regarded as a person's facade; when everyone talks to each other, if they see a pair of disorganized teeth, they will have an impact on people's first impression, and the first impression between people will often determine many key points. Therefore, modern people care about the care and cleanliness of their teeth.

The most common way to adjust the position and shape of teeth is to wear braces; where the braces are also divided into many kinds, and the more popular way is to use the traditional orthotic cooperating with the rope body to pull to gradually change the position of the teeth.

However, sometimes the teeth may be skewed or the spacing is too large, so that just using the traditional orthotic cooperating with the rope body to pull is not enough to correct; therefore the traditional tractor cooperating with the rubber band is added to adjust; but the traditional tractor has the defect which the rope body is easy to be loosen; therefore the industry has improved to develop the conventional tractor.

The conventional tractor includes a columnar-body, a base at the end of the columnar-body, and a round-hook-body at the other end of the columnar-body; which the rubber-band is hung on the round-hook-body to produce a traction effect;

However, the round-hook-body needs to be set in parallel with the teeth, and the opening needs to face away from the side of the rubber band to keep the rubber band from falling off; if the round-hook-body forms an angle with the teeth or the opening faces the rubber band, the rubber band is likely to fall off; therefore, it is necessary to make two styles, the left-hook and the right-hook; in addition to being more expensive, it is more troublesome to use.

### SUMMARY OF THE INVENTION

The main purpose of the present invention is for convenient use.

The other main purpose of the present invention is for preventing from being slipped, loosen, and falling-off.

In order to achieve the above-mentioned objectives, the present invention comprises: at least one extension main-body; wherein at least one seat-body is defined at one end of the extension main-body, and at least one tractive-body is defined at the end of the extension main-body facing away from the seat-body; wherein the tractive-body and the extension main-body form at least one angle, and the end of the tractive-body facing away from the extension main-body defines at least one blocking-stopping-body; wherein the cross-sectional area of the blocking-stopping-body is larger than the cross-sectional area of tractive-body.

When the present invention is used, at least one dental orthotic is respectively set on the different teeth; and at least one dental correction archwire is fixed through the dental orthotic and at least one bone nail is set on the gum; then, the dental traction device is taken and the seat-body is fixed on the dental correction archwire; and the elastic element is taken to respectively fix its two ends on the bone nail and then is bypass the blocking-stopping-body to stick and engage on the tractive-body; at this time, since the tractive-body forms an angle with the extension main-body and the blocking-stopping-body has no directivity, the elastic element can be more easily and rapidly stuck and engaged; wherein the blocking-stopping-body can be cooperated with the tractive-body to block, stop the and fix elastic element to prevent from being slipped, loosen, and falling-off; and the elastic element will generate a pulling force through the elastic contraction to the tractive-body, which the pulling force is towards the bone nail, and the extension main-body is used as the force moment to apply the pulling force to the dental correction archwire, each dental orthotic, and each tooth to produce the traction correction effect. With the above-mentioned technology, the present invention can break through the problems of expensive cost and troublesome use of the conventional tractor, and so as to achieve the practicality and progressiveness which is convenient in use and avoids falling-off.

### BRIEF DESCRIPTION OF THE DRAWINGS

FIG. 1 is a stereoscopic schematic diagram of the preferred embodiment of the present invention.

FIG. 2 is a side-view schematic diagram of the preferred embodiment of the present invention.

FIG. 3 is a setting schematic diagram of the preferred embodiment of the present invention.

FIG. 4 is a sticking-engaging schematic diagram of the preferred embodiment of the present invention.

FIG. 5 is a traction schematic diagram of the preferred embodiment of the present invention.

FIG. 6 is a correction schematic diagram of the preferred embodiment of the present invention.

FIG. 7 is an implementation schematic diagram of another preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

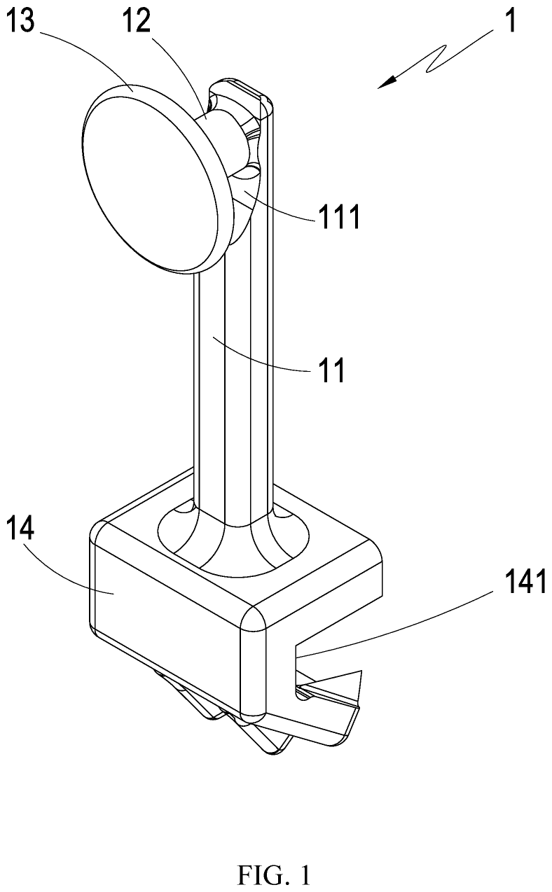

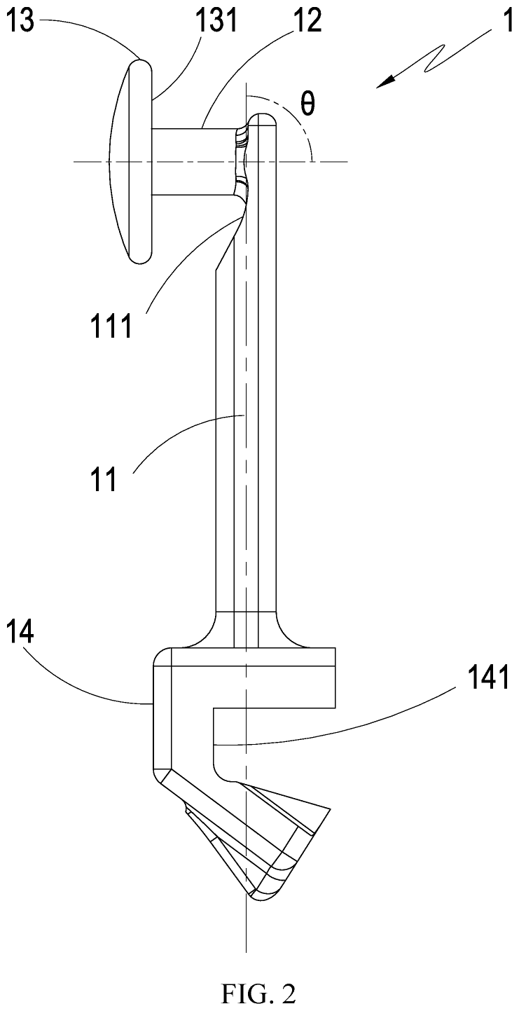

Please refer to FIG. 1 and FIG. 2, which are the stereoscopic schematic diagram and the side-view schematic diagram of the preferred embodiment of the present invention; it can be clearly seen from the figures that the dental traction device 1 of the present invention comprises: at least one extension main-body 11, at least one tractive-body 12, at least one blocking-stopping-body 13, and at least one seat-body 14; wherein the material of the dental traction device 1 comprises one of metal, ceramic, or plastic, and the tractive-body 12 is defined at one end of the extension main-body 11; wherein the extended center-line of the tractive-body 12 and the extended center-line of the extension main-body 11 form at least one angle θ; in the figure, the angle θ is 90 degrees as an example to explain, and the extension main-body 11 adjacent to the end of the tractive-body 12 defines at least one guiding-portion 111.

The blocking-stopping-body 13 is one of a circular type, an elliptical type, a semi-circular type, a long-strip type, or a polygonal type; in the embodiment, the blocking-stopping-body 13 is a circular type as an example to explain; wherein the blocking-stopping-body 13 is defined at the end of the tractive-body 12 facing away from the extension main-body 11; wherein the cross-sectional area of the blocking-stopping-body 13 is larger than the cross-sectional area of the tractive-body 12, so the tractive-body 12 and the blocking-stopping-body 13 have no directivity problem; and in the present embodiment, at least one plane-portion 131 is defined at the side of the blocking-stopping-body 13 adjacent to the tractive-body 12.

The seat-body 14 is defined at the end of the extension main-body 11 facing away from the tractive-body 12, and the seat-body 14 defines at least one accommodation-portion 141; wherein the above-mentioned is only one implementation type of the present invention, and the type thereof is not limited thereto.

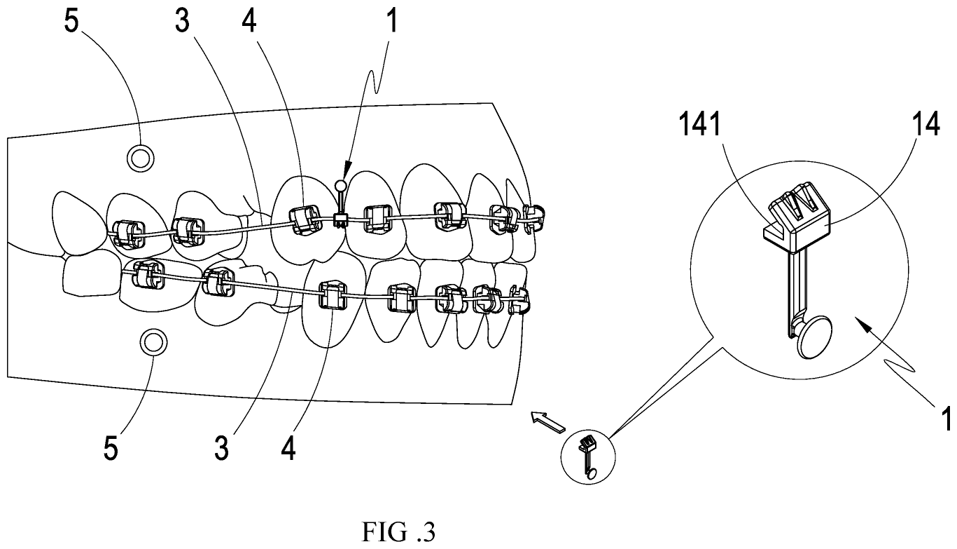

Please simultaneously refer to FIG. 1 to FIG. 6, which are the stereoscopic schematic diagram, side-view schematic diagram, setting schematic diagram, sticking-engaging schematic diagram, traction schematic diagram, and correction schematic diagram of the preferred embodiment of the present invention; and please refer to FIG. 3, it can be clearly seen from the figure that when the present invention is to be used; at least one bone nail 5 is first placed on the gum, and at least one dental orthotic 4 is respectively set on different tooth; and at least one dental correction archwire 3 is connected with each dental orthotic 4, and at least one dental traction device 1 is set on the dental correction archwire 3; in the figure, the upper and lower rows of teeth are respectively set with a plurality of dental orthotics 4, a dental correction archwire 3, a bone nail 5, and a dental traction device 1 as an example to explain; because the bone nail 5, the dental orthotics 4, and the dental correction archwire 3 are well-known technologies in the industry, so they will not be further described here.

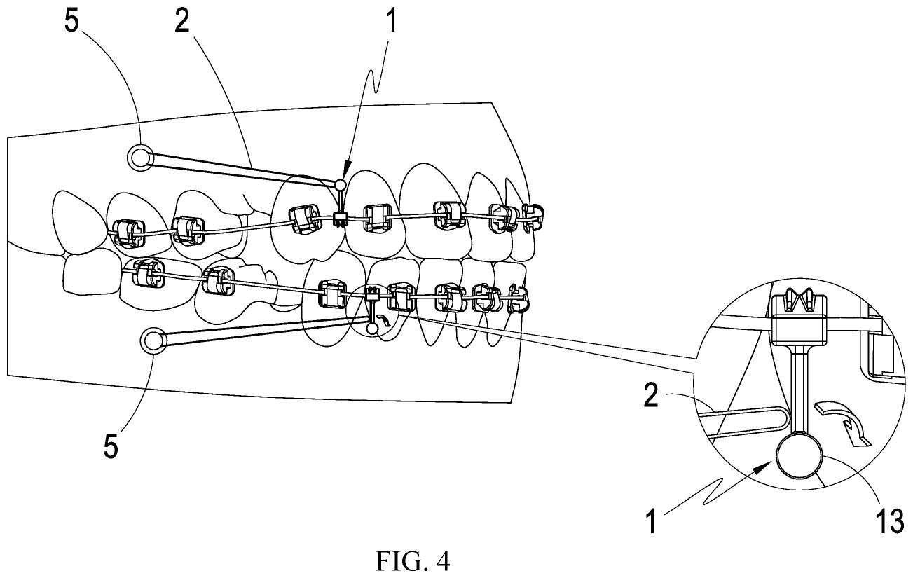

At this time, the dental traction device 1 will accommodate the dental correction archwire 3 through the accommodation-portion 141 of the seat-body 14 to achieve the indirect connection with the tooth as shown in FIG. 4; then, at least one elastic element 2 is taken, which the elastic element 2 is one of an elastic rubber ring or a spring, and the elastic rubber ring is used as an example to explain in the figure; which the two ends of the elastic element 2 are respectively stuck and engaged on the bone nail 5, and it can be stuck and engaged on the tractive-body 12 after bypassing the blocking-stopping-body 13, so the use is quite fast and convenient.

At this time, the effect of guiding the elastic member 2 is generated by the structural design of the guiding-portion 111, which makes the sticking-engaging more easy and convenient; since the extending center-line of the tractive-body 12 forms at least one angle θ with the extended center-line of the extension main-body 11 and the cross-sectional area of the blocking-stopping-body 13 is larger than which of the tractive-body 12, the tractive-body 12 and the blocking-stopping-body 13 have no directivity problem; the dental traction device 1 can be freely placed on the left or right side of the bone nail 5; which the blocking-stopping-body 13 can avoid the teeth by the bending concept of the angle θ of the tractive-body 12; and the blocking-stopping-body 13 can cooperate with the tractive-body 12 to block and stop the elastic element 2 through the large-area blocking-stopping concept; thereby generating a fixing effect to avoid being loosen and fallen off; and the plane-portion 131 is used to block and stop the elastic element 2 to reduce the loosen and fallen-off probability.

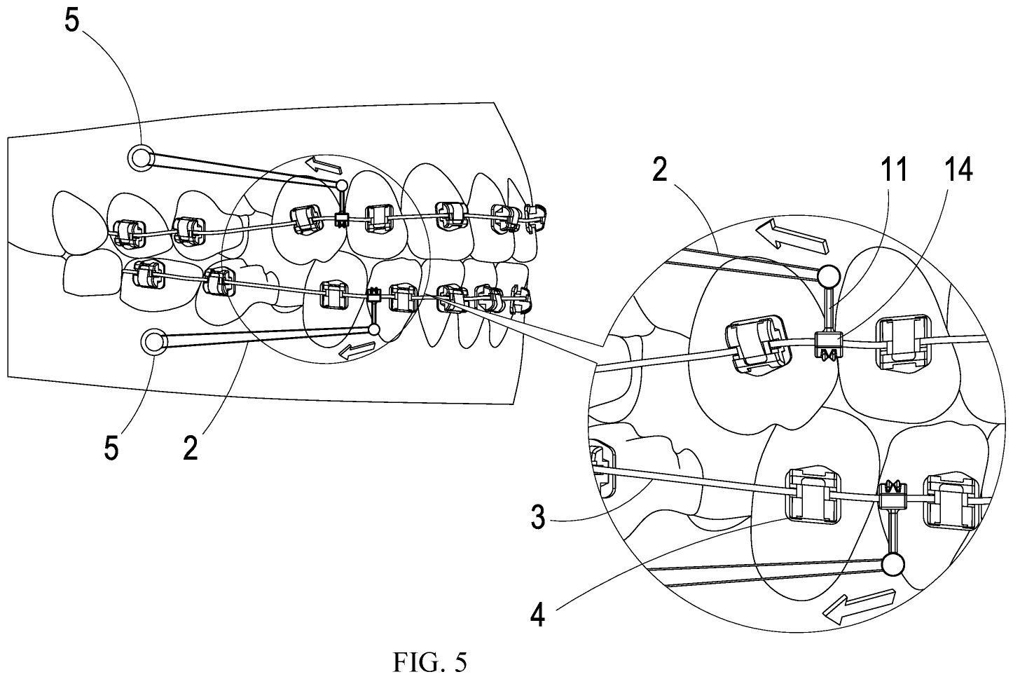

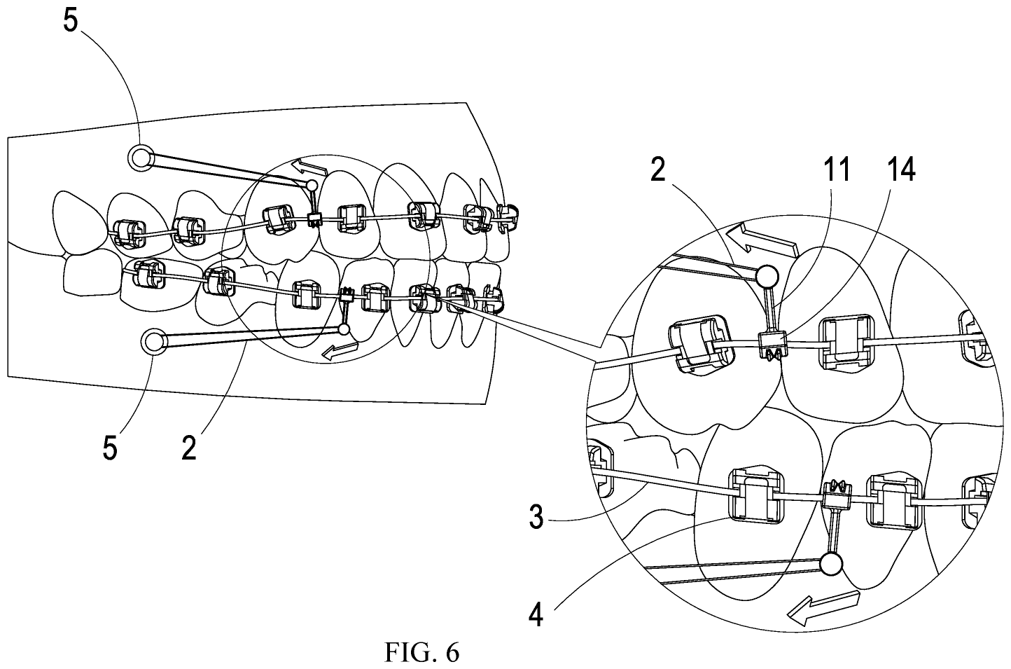

Please simultaneously refer to FIG. 5 and FIG. 6; since the bone nail 5 is fixed to the gum, the elastic force caused by the contraction of the elastic element 2 will apply force to the dental correction archwire 3 through the tractive-body 12, the extension main-body 11, and the seat-body 14; and is transmitted to each of the teeth via each of the dental orthotic 4 to generate a pulling force to the teeth toward the direction of the bone nail 5; and at the same time, since the elastic element 2 is stuck and engaged on the guiding-portion 111; when the elastic element 2 transmits the pulling force, the seat-body 14 is as the circle-center and the extension main-body 11 is as the axis to generate a status of force moment to improve the traction effect and correction effect of the tooth, which the tooth is displaced and closed to each other.

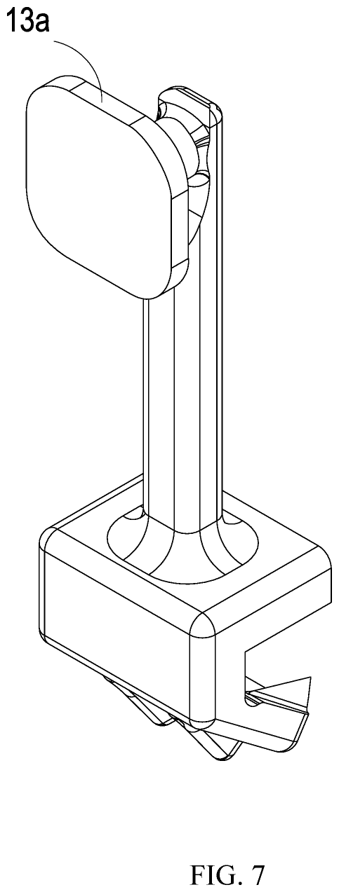

Please simultaneously refer to FIG. 7, which is the implementation schematic diagram of another preferred embodiment of the present invention; it can be clearly seen from the figure that this embodiment is almost the same with the above embodiment; the difference is that in the present embodiment, the blocking-stopping-body 13a is embodied in a polygonal type (quadrilateral type) to explain the freedom and variety of the present invention.

Therefore, the key of the dental traction device of the present invention to improve the conventional technology is lied in that:
1. Through the cooperation of the extension main-body 11, the tractive-body 12, the blocking-stopping-body 13, and the seat-body 14; the present invention achieves the practicality and progressiveness which is convenient in use and avoids falling-off.
2. Through the cooperation of the extension main-body 11, the tractive-body 12, the blocking-stopping-body 13, and the seat-body 14; the present invention achieves the practicality and progressiveness which generates a force moment to improve the effect of the tooth displacement, which the tooth is closed to each other.

I claim:

1. A dental traction device, which comprises:
at least one extension main-body;
at least one tractive-body defined at one end of the extension main-body, wherein the extended center-line of the tractive-body and the extended center-line of the ex-tension main-body form at least one angle;
at least one blocking-stopping-body defined at the end of the tractive-body facing away from the extension main-body; and the cross-sectional area of the blocking-stopping-body is larger than the cross-sectional area of the tractive-body; and
at least one seat-body defined at the end of the extension main-body facing away from the tractive-body.

2. The dental traction device according to claim 1, wherein the end of the extension main-body adjacent to the tractive-body is defined with at least one guiding-portion.

3. The dental traction device according to claim 1, wherein the side of the blocking-stopping-body adjacent to the tractive-body is defined with at least one plane-portion.

4. The dental traction device according to claim 1, wherein the tractive-body is set with at least one elastic element.

5. The dental traction device according to claim 1, wherein the elastic element is one of an elastic rubber ring or a spring.

6. The dental traction device according to claim 1, wherein the seat-body is defined with at least one accommodation-portion.

7. The dental traction device according to claim 6, wherein the accommodation-portion is set with at least one dental correction archwire.

8. The dental traction device according to claim 7, wherein the dental correction archwire is set with at least one dental orthotic, and the dental orthotic is set on at least one tooth.

9. The dental traction device according to claim 1, wherein the blocking-stopping-body is one of a circular type or an elliptical type.

10. The dental traction device according to claim 1, wherein the blocking-stopping-body is one of a semi-circular type, a long-strip type, or a polygonal type.

11. The dental traction device according to claim 1, wherein the material of the dental traction device comprises one of metal, ceramic, or plastic.
